(19) United States
(12) Patent Application Publication
(10) Pub. No.: US 2008/0030335 A1
(43) Pub. Date: Feb. 7, 2008

(54) TAG extracting device, TAG extracting method, and computer product

(75) Inventors: Hirotake Nishida, Machida (JP); Norihiro Nakamura, Kawasaki (JP); Haruo Obana, Kanagawa (JP); Takeshi Miki, Kanagawa (JP); Ichirou Ono, Kanagawa (JP); Takao Nakamura, Kanagawa (JP); Hideshi Numata, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: FUJITSU LIMITED, Kawasaki (JP); Ajinomoto Co., Inc., Tokyo (JP)

(21) Appl. No.: 11/819,509

(22) Filed: Jun. 27, 2007

Related U.S. Application Data
(63) Continuation of application No. PCT/JP04/19618, filed on Dec. 28, 2004.

(51) Int. Cl. G08B 13/14

(52) U.S. Cl. 340/572.1

(57) ABSTRACT

A plurality of RFID tags that store therein position information and other information are arranged at different locations, and a tag extracting device extracts at least one RFID tag among the RFID tags. The tag extracting device includes a reading unit that reads position information from a plurality of information-read RFID tags from among the plurality of RFID tags; a determining unit that determines, based on read position information, an area where the information-read RFID tags are concentrated; and an extracting unit that extracts at least one RFID tag from among the information-read RFID tags as a target RFID tag whose the other information is to be used in subsequent processing.

### BACKGROUND OF THE INVENTION

1. Field of the Invention

The present invention relates to a technology for extracting certain radio frequency identification (RFID) tag from among a plurality of RFID tags.

2. Description of the Related Art

In recent years, there has been progress in commercialization of RFID tags. The RFID tags are gradually becoming popular in various fields such as distribution or logistics.

An RFID tag, also sometimes referred to as an integrated circuit (IC) tag, is configured to store therein various data. The RFID tag can communicate with a reader/writer using radio waves. The reader/writer reads data from the RFID tag and writes data to the RFID tag.

As disclosed in Japanese Patent Application Laid-open No. 2001-116583, and as shown in FIG. 14, RFID tags 21 to 216 are attached to a rack 1 used to stack packages or goods. A reader/writer 3 communicates with the RFID tags 21 to 216 and detects a position of a rack where to load or unload certain package.

In the technology disclosed in Japanese Patent Application Laid-open No. 2004-271299, each of a plurality of housing units includes a reader/writer. Each housing unit houses a container including an RFID tag. The reader/writer reads information from the RFID tag. The reader/writer reads information from the RFID tag when the container is housed in the housing unit.

It has been know that, sometimes, reflection and wraparound of communication radio waves takes place between a reader/writer and RFID tags. When such reflection and wraparound of communication radio waves takes place, error can occur in data reading or writing in the communication between the reader/writer and the RFID tags.

Moreover, when 2.45 GHz-band or UHF-band communication radio waves, which has a long communication range, is used for communication between a reader/writer and RFID tags, because many RFID tags may be located in the communication range, information may be read erroneously from an RFID tag other than the desired RFID tag.

Furthermore, sometimes a reader/writer cannot communicate with an RFID tag. However, there is no way to decide whether the communication is not possible due to a defective RFID tag or due to radio interference of some sort. If communication is not possible with an RFID tag, a reader/writer may needlessly repeat the process of a attempting to establish a communication with the RFID tag.

### SUMMARY OF THE INVENTION

It is an object of the present invention to at least partially solve the problems in the conventional technology.

According to an aspect of the present invention, a tag extracting device that extracts an RFID tag from among a plurality of RFID tags that store therein position information and other information, includes a reading unit that reads position information from a plurality of information-read RFID tags from among the plurality of RFID tags; a determining unit that determines, based on read position information, a concentration area that is an area in which the information-read RFID tags are concentrated; and an extracting unit that extracts at least one RFID tag from among the information-read RFID tags as a target RFID tag whose the other information is to be used in subsequent processing.

According to another aspect of the present invention, a tag extracting device that extracts an RFID tag from among a plurality of RFID tags that store therein position information and other information, includes a storing unit that stores therein default position information of each of the RFID tags; a reading unit that reads position information from a plurality of information-read RFID tags from among the plurality of RFID tags; and an extracting unit that extracts an RFID tag from among the RFID tags other than the information-read RFID tags as a defective RFID tag based on the default position information in the storing unit and the position information read from the information-read RFID tags.

According to still another aspect of the present invention, a tag extracting device that extracts an RFID tag from among a plurality of RFID tags that store therein position information and other information, includes a plurality of antennas arranged at different positions and communicable with the RFID tags; a reading unit configured to read position information from the plurality of RFID tags via the antennas; a storing unit that stores therein information on each RFID tag about whether the reading unit has successfully read by position information from that RFID tag; and an extracting unit that extracts at least one RFID tag from among the RFID tags as a target RFID tag whose the other information is to be used in subsequent processing based on the information in the storing unit.

According to still another aspect of the present invention, a method of extracting an RFID tag from among a plurality of RFID tags that store therein position information and other information includes reading position information from a plurality of information-read RFID tags from among the plurality of RFID tags; determining, based on read position information, a concentration area that is an area in which the information-read RFID tags are concentrated; and extracting at least one RFID tag from among the information-read RFID tags as a target RFID tag whose the other information is to be used in subsequent processing.

According to still another aspect of the present invention, a computer-readable recording medium stores therein a computer program that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram of a tag extracting process according to a first embodiment of the present invention;

FIG. 2 is a block diagram of a tag extracting device according to the first embodiment;

FIG. 3 is a flowchart of a tag extracting process according to the first embodiment;

FIG. 4 is an explanatory diagram of a barycentric position calculation according to a variation example of the first embodiment;

FIG. 5 is a flowchart of a tag extracting process according to a variant of the first embodiment;

FIG. 6 is an explanatory diagram of a tag extracting process according to a second embodiment of the present invention;

FIG. 7 is a block diagram of a tag extracting device according to the second embodiment;

FIG. 8 is a flowchart of a tag extracting process according to the second embodiment;

FIG. 9 is an explanatory diagram of a tag extracting process according to a third embodiment of the present invention;

FIG. 10 is a block diagram of a tag extracting device according to the third embodiment;

FIG. 11 is an example of reading success/failure information shown in FIG. 10;

FIG. 12 is a flowchart of the tag extracting process according to the third embodiment;

FIG. 13 is a block diagram of a hardware configuration of a computer serving as the tag extracting devices according to the embodiments; and

FIG. 14 is an explanatory diagram of use of RFID tags.

### DETAILED DESCRIPTION OF THE PREFERRED EMBODIMENTS

Exemplary embodiments of the present invention are below described with reference to the attached drawings. The invention is not limited to the embodiments.

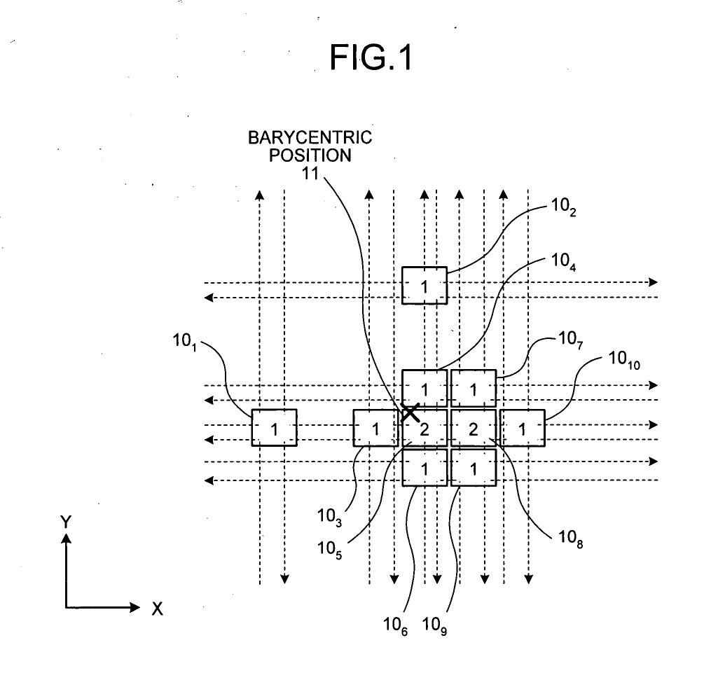

First, a tag extracting process according to a first embodiment of the present invention will be described. FIG. 1 is an explanatory diagram for explaining the tag extracting process according to the first embodiment. A reader/writer excludes information read from erroneously-read RFID tags, which are RFID tags that are read erroneously due to reflection or wraparound of communication radio waves, and considers only information read from correctly-read RFID tags.

It is expected that erroneously-read RFID tags are located away from the reader/writer than correctly-read RFID tags. Moreover, it is expected that the number of erroneously-read RFID tags is much smaller than that of correctly-read RFID tags.

Based on the above facts, if locations of the all the RFID tags is determined, then, RFID tags located away from the area in which most of the RFID tags are concentrated can be determined as erroneously-read RFID tags. Furthermore, information read from the RFID tags located in the area in which most of the RFID tags are concentrated is given importance.

Specifically, a barycentric position of the RFID tags is calculated as a position of the area in which the RFID tags are concentrated. The RFID tag closest to the barycentric position is extracted as the RFID tag of which the information is to be used.

FIG. 1 depicts the positions of RFID tags 10₁ to 10₁₀ from which information has been read by the reader/writer. Information has been erroneously read from the RFID tags 10₁ and 10₂ due to reflection or wraparound of communication radio wave.

Position information of the RFID tags 10₁ to 10₁₀ is respectively stored in advance in the RFID tags 10₁ to 10₁₀. The reader/writer reads the position information from each of the RFID tag 10₁ to 10₁₀, and calculates a barycentric position 11 of the RFID tags 10₁ to 10₁₀ based on following Equations:
X_{C}=ΣWᵢXᵢ/ΣWᵢ (1)
Y_{C}=ΣWᵢYᵢ/ΣWᵢ (2)

X_{C} is an X coordinate and Y_{C} is a Y coordinate of the barycentric position 11 of the RFID tag. Xᵢ is an X coordinate and Yᵢ is a Y coordinate of an i-th RFID tag, and Wᵢ is a weight assigned to the i-th RFID tag.

The weight Wᵢ is calculated as follows. First, four values, W_{Xi}, W_{XRi}, W_{Yi}, and W_{YRi}, are respectively assigned to each RFID tag 10₁ to 10₁₀, for each direction. The directions are a forward X-axis direction, a reverse X-axis direction, a forward Y-axis direction, and a reverse Y-axis direction.

For example, regarding the forward X-axis direction, when a certain RFID tag from among the RFID tags 10₁ to 10₁₀ is adjacent to other RFID tags in the forward X-axis direction, the W_{Xi} of that certain RFID tag is set to a value that increases by one from an initial value “1” in the forward X-axis direction. When a certain RFID tag from among the RFID tags 10₁ to 10₁₀ is isolated, i.e., not adjacent to the other RFID tags, in the forward X-axis direction, the W_{Xi} is of that RFID tag is set to an initial value “1”. In the example of FIG. 1, the W_{Xi} of each RFID tag 10₃, 10₅, 10₈, and 10₁₀ is respectively “1”, “2”, “3”, and “4”. The W_{Xi} of the isolated RFID tags 10₁ and 10₂ is “1”.

Regarding the reverse X-axis direction, when a certain RFID tag from among the RFID tags 10₁ to 10₁₀ is adjacent to other RFID tags in the reverse X-axis direction, the W_{XRi} of that RFID tag is set to a value that increases by one from an initial value “1” in the reverse X-axis direction. When a certain RFID tag from among the RFID tags 10₁ to 10₁₀ is isolated in the reverse X-axis direction, the W_{XRi} of that RFID tag is set to an initial value “1”. In the example of FIG. 1, the W_{XRi} of each RFID tag 10₃, 10₅, 10₈, and 10₁₀ is respectively “4”, “3”, “2”, and “1”. The W_{XRi} of the isolated RFID tags 10₁ and 10₂ is “1”.

Regarding the forward Y-axis direction, when a certain RFID tag from among the RFID tags 10₁ to 10₁₀ is adjacent to other RFID tags 10₁ to 10₁₀ in the forward Y-axis direction, the W_{Yi} of that RFID tag RFID tag is set to a value that increases by one from an initial value “1” in the forward Y-axis direction. When a certain RFID tag from among the RFID tags 10₁ to 10₁₀ is isolated in the forward Y-axis direction, the W_{Yi} of that RFID tag is set to an initial value “1”. In the example of FIG. 1, the W_{Yi} of each RFID tag 10₄, 10₅, and 10₆ is respectively “1”, “2”, and “3”. The W_{Yi} of each of the isolated RFID tags 10₁ and 10₂ is “1”.

Regarding the reverse Y-axis direction, when a certain RFID tag from among the RFID tags 10₁ to 10₁₀ is adjacent to other RFID tag 10₁ to 10₁₀ in the reverse Y-axis direction, the W_{YRi} of that RFID tag is set to a value that increases by one from an initial value “1” in the reverse Y-axis direction. When a certain RFID tag from among the RFID tags 10₁ to 10₁₀ is isolated in the reverse Y-axis direction, the W_{YRi} of that RFID tag is set to an initial value “1”. In the example of FIG. 1, the W_{YRi} of each RFID tag 10₄, 10₅, and 10₆ is respectively “3”, “2”, and “1”. The W_{YRi} of the isolated RFID tags 10₁ and 10₂ is “1”.

The weight Wᵢ of each RFID tag 10₁ to 10₁₀ is calculated by using the following Equation:
Wᵢ=min (W_{Xi},W_{XRi},W_{Yi},W_{YRi}) (3)
where min(W_{Xi}, W_{XRi}, W_{Yi}, W_{YRi}) is the smallest value among values W_{Xi}, W_{XRi}, W_{Yi}, and W_{YRi}.

The weight Wᵢ of each of the RFID tag 10₁ to 10₁₀ calculated based on Equation (3) is, shown in FIG. 1, “1”, “1”, “1”, “1”, “2”, “1”, “1”, “2”, “1” and “1”. Thus, the weight of the RFID tags 10₅ and 10₈ is the greatest among the RFID tags 10₁ to 10₁₀, which means that the RFID tags 10₅ and 10₈ are the closest to the barycentric position 11. Therefore, the RFID tag 10₅, which is closest to the barycentric position 11, is defined as an RFID tag whose positional information is to be used. Moreover, the RFID tags 10₁ and 10₂, which are isolated from the barycentric position 11, are excluded from consideration; because, they may be affected due to reflection or the wraparound of communication radio waves. In this way, the process of reading the necessary information from the RFID tags 10₁ to 10₁₀ is efficiently performed.

As explained above, if an RFID tag is adjacent to other RFID tags, the weight of that RFID tag is increased by one from the initial value “1”. Alternatively, the weight of such an RFID tag can be increased nonlinearly, such as “1”, “2”, “2²”, and “2³”. If the weight is increased nonlinearly, a weight of the area in which the RFID tags are concentrated can be increased and the RFID tags that are closer to the concentrated area can be extracted.

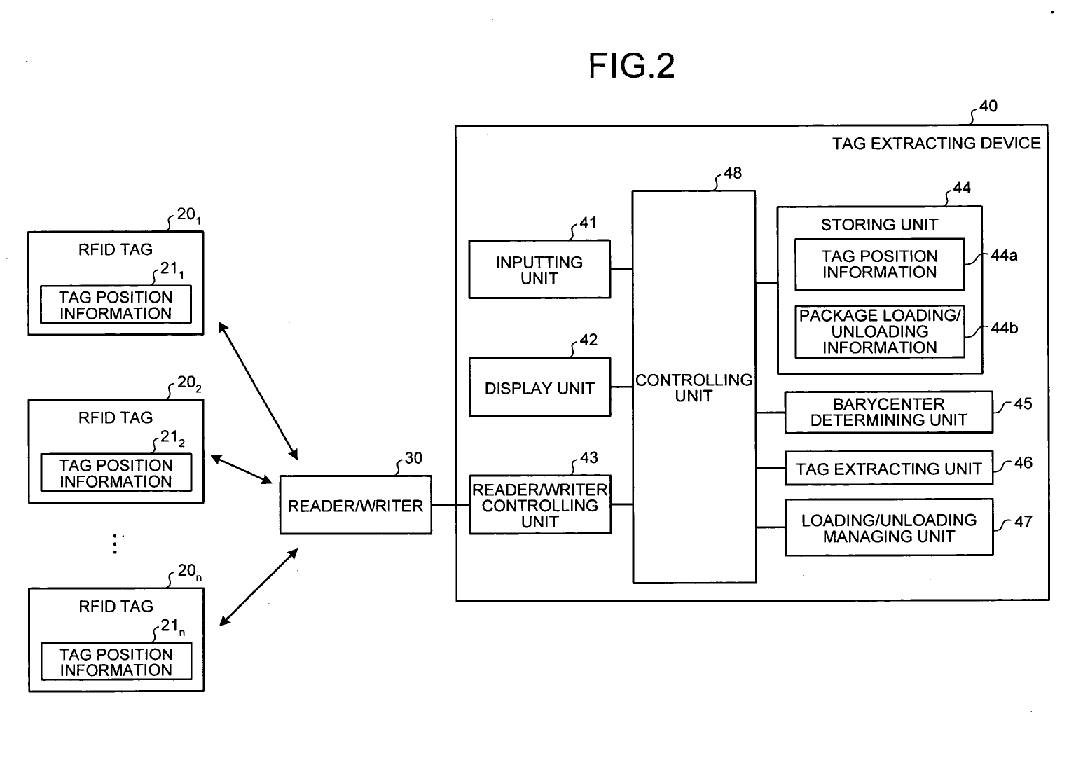

Next, a functional configuration of the tag extracting device according to the first embodiment will be described. FIG. 2 depicts a tag extracting device 40 according to the first embodiment.

The tag extracting device 40 is connected to a reader/writer 30. The reader/writer 30 includes an antenna and communicates with a plurality of RFID tags 20₁ to 20ₙ by using radio waves. In other words, the reader/writer 30 can read information stored in the RFID tags 20₁ to 20ₙ, or can write information in the RFID tags 20₁ to 20ₙ.

Specifically, the reader/writer 30 reads tag position information 21₁ to 21ₙ stored in the respective RFID tags 20₁ to 20ₙ. The tag position information is the information relating to the attachment position of an RFID tag. The tag position information is, for example, a coordinate position in a two-dimensional Cartesian coordinate system.

The tag extracting device 40 can be installed on a forklift or the like along with the reader/writer 30. On the other hand, the RFID tags 20₁ to 20ₙ are attached to a rack 1 in which packages or goods are stacked. In this configuration, the tag extracting device 40 reads the tag position information from the RFID tags and performs a process of determining which of the tag position information is reliable and which is not.

Some of the RFID tags from among the RFID tags 20₁ to 20ₙ may be nearer to the reader/writer 30, while others are away. The tag position information read from the RFID tags that are nearer to the reader/writer 30 is more reliable than the tag position information read from the RFID tags that are away.

The tag extracting device 40 includes an inputting unit 41, a display unit 42, a reader/writer controlling unit 43, a storing unit 44, a barycenter determining unit 45, a tag extracting unit 46, a loading/unloading managing unit 47, and a controlling unit 48.

The inputting unit 41 is an inputting device such as a keyboard, a button, and a switch. The display unit 42 is a display device such as a display apparatus. The reader/writer controlling unit 43 controls communication between the reader/writer 30 and the RFID tags 20₁ to 20ₙ performed using radio waves.

Specifically, the reader/writer controlling unit 43 requests that the reader/writer 30 transmit communication radio waves to the RFID tags 20₁ to 20ₙ. The reader/writer controlling unit 43 also controls the intensity of the communication radio waves.

The storing unit 44 is a storage device such as a hard disk device. The storing unit 44 stores tag position information 44a and package loading/unloading information 44b.

The tag position information 44a includes the tag position information 21₁ to 21ₙ read from the RFID tags 20₁ to 20ₙ. The package loading/unloading information 44b includes information related to loading and unloading of a package, such as information on a rack used to load and unload the package and information on a date on which the package has been loaded or unloaded.

The barycenter determining unit 45 performs a process of determining respective barycentric positions of the RFID tags 20₁ to 20ₙ, by using Equations (1) to (3), as described with reference to FIG. 1.

The tag extracting unit 46 extracts the RFID tag 20₁ to RFID tag 20ₙ closest to the barycentric position determined by the barycenter determining unit 45 as the RFID tag of which the information is to be used. The tag extracting unit 46 excludes the RFID tags 20₁ to 20ₙ that is read as a result of the reflection or the wraparound phenomenon of the radio waves.

The loading/unloading managing unit 47 performs, for example, a process of judging whether a rack that is near a front face of the reader/writer is the rack used to load and unload the package, based on the tag position information 21₁ to 21ₙ of the RFID tags 20₁ to 20ₙ extracted by the tag extracting unit 46. The loading/unloading managing unit 47 performs a process of storing information related to package loading and unloading operations in the storing unit 44 as the package loading/unloading information 44b.

The controlling unit 48 controls the overall tag extracting device 40 and handles reception and transmission of data among each function.

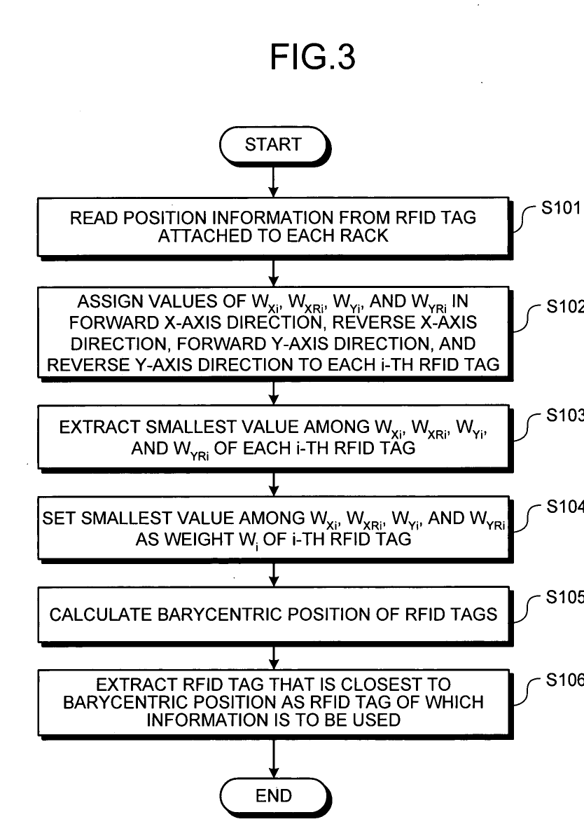

Next, procedures performed in the tag extracting process according to the first embodiment will be described. FIG. 3 is a flowchart of the procedures performed in the tag extracting process according to the first embodiment.

First, the reader/writer controlling unit 43 of the tag extracting device 40 controls the reader/writer 30 and reads the tag position information 21₁ to 21ₙ from the RFID tags 20₁ to 20ₙ attached to each rack used to load and unload the packages (Step S101).

Then, the barycenter determining unit 45 assigns the values of W_{Xi}, W_{XRi}, W_{Yi}, and W_{YRi} in the forward X-axis direction, the reverse X-axis direction, the forward Y-axis direction, and the reverse Y-axis direction to each RFID tag 20₁ to 20ₙ using the method described with reference to FIG. 1 (Step S102).

Next, the barycenter determining unit 45 extracts a smallest value among the W_{Xi}, W_{XRi}, W_{Yi}, and W_{YRi} of each RFID tag 20₁ to 20ₙ as indicated by Equation (3) (Step S103). The smallest value is set as the weight Wᵢ of the RFID tag 20₁ to 20ₙ (Step S104).

Then, the barycenter determining unit 45 calculates the barycentric position of the RFID tags 20₁ to 20ₙ using Equations (1) and (2) (Step S105). Then, the tag extracting unit 46 extracts the RFID tags 20₁ to 20ₙ in a position closest to the barycentric position as the RFID tag of which the information is to be used (Step S106) The tag extracting process is completed.

As described above, according to the first embodiment, when the position information related to the RFID tags 20₁ to 20ₙ is stored as the tag position information 21₁ to 21ₙ in each RFID tag 20₁ to 20ₙ, the reader/writer controlling unit 43 controls the reading of the tag position information 21₁ to 21ₙ stored in each RFID tag 20₁ to 20ₙ. Based on the tag position information 21₁ to 21ₙ read by the reader/writer controlling unit 43, the barycenter determining unit 45 judges the position in which the RFID tags 20₁ to 20ₙ of which the information has been read are concentrated. Based on information related to the position, the tag extracting unit 46 extracts the RFID tags 20₁ to 20ₙ storing the information to be used. Therefore, unnecessary information of the RFID tags 20₁ to 20ₙ read as a result of the reflection or the wraparound phenomenon of the radio waves is excluded, and the process of reading necessary information from the RFID tags 20₁ to 20ₙ can be efficiently performed.

According to the first embodiment, the barycenter determining unit 45 calculates the barycentric position of each RFID tag 20₁ to 20ₙ from which the tag position information 21₁ to 21ₙ has been read. As a result, the barycenter determining unit 45 judges the position in which the RFID tags 20₁ to 20ₙ from which the tag position information 21₁ to 21ₙ has been read are concentrated. Therefore, the unnecessary information of the RFID tags 20₁ to 20ₙ read as a result of the reflection or the wraparound phenomenon of the radio waves is excluded by the barycentric position being determined, and the process of reading necessary information from the RFID tags 20₁ to 20ₙ can be efficiently performed.

According to the first embodiment, the barycenter determining unit 45 performs weighting of the position information related to the RFID tags 20₁ to 20ₙ, based on an adjacency of the RFID tags 20₁ to 20ₙ from which the tag position information 21₁ to 21ₙ has been read. Based on the weighted position information, the barycentric position is calculated. Therefore, the position in which the RFID tags 20₁ to 20ₙ from which the tag position information 21₁ to 21ₙ have been read are concentrated can be determined with more accuracy.

According to the first embodiment, when, among the RFID tags 20₁ to 20ₙ from which the tag position information 21₁ to 21ₙ have been read, there are the RFID tags 20₁ to 20ₙ that are mutually adjacent along the forward X-axis direction, the reverse X-axis direction, the forward Y-axis direction, and the reverse Y-axis direction, the barycenter determining unit 45 assigns a numerical value increasing gradually from the initial value “1” to each RFID tag 20₁ to 20ₙ for each direction. When there are no the RFID tags 20₁ to 20ₙ that are mutually adjacent along the forward X-axis direction, the reverse X-axis direction, the forward Y-axis direction, and the reverse Y-axis direction, the barycenter determining unit 45 assigns the initial value “1” to the RFID tags 20₁ to 20ₙ for each direction. Among the numerical values corresponding to each direction assigned to each RFID tag 20₁ to 20ₙ, the smallest numerical value is set as the weight of the position information related to the RFID tags 20₁ to 20ₙ. Therefore, the weight of the position information related to the RFID tags 20₁ to 20ₙ can be appropriately assigned. The position in which the RFID tags 20₁ to 20ₙ from which the tag position information 21₁ to 21ₙ have been read are concentrated can be more accurately determined.

According to the first embodiment, the barycentric position of the RFID tags 20₁ to 20ₙ is calculated using a method such as that described in FIG. 1. However, the calculation of the barycentric position can be performed using another method.

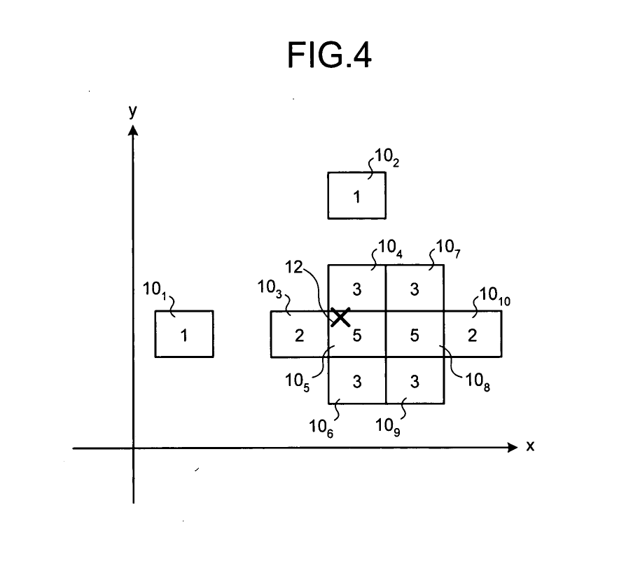

FIG. 4 is a diagram explaining the calculation of the barycentric position according to a variation example of the first embodiment. FIG. 4 shows the positions of the RFID tags 10₁ to 10₁₀ of which the information has been read by the reader/writer, as in FIG. 1. The RFID tags 10₁ and 10₂ are RFID tags of which the information has been read as a result of the reflection or the wraparound phenomenon of the radio waves.

The weight Wᵢ of each RFID tags 10₁ to 10₁₀ is determined by the number of RFID tags 10₁ to 10₁₀ adjacent to each RFID tags 10₁ to 10₁₀. Specifically, the initial value of the weight Wᵢ of each RFID tags 10₁ to 10₁₀ is set to “1”. A process is performed in which “1” is added to the weight Wᵢ by the number of RFID tag 10₁ to RFID tag 10₁₀ adjacent to the RFID tags 10₁ to 10₁₀.

For example, the RFID tag 10₅ in FIG. 4 is adjacent to four RFID tags, 10₃, 10₄, 10₆, and 10₈. Therefore, the weight Wᵢ of the RFID tag 10₅ is “5”. The weight Wᵢ of the other RFID tags 10₁ to 10₁₀ is similarly calculated.

As a result, the weight Wᵢ of each RFID tag 10₁ to 10₁₀ is respectively set to “1”, “1”, “2”, “3”, “5”, “3”, “3”, “5”, “3”, and “2”, as shown in FIG. 4.

Then, by using the weight Wᵢ and Equations (1) and (2), a barycentric position 12 of the RFID tags 10₁ to 10₁₀ is calculated.

Here, “1” is added to the weight Wᵢ by the number of other RFID tag 10₁ to RFID tag 10₁₀ adjacent to the RFID tag 10₁ to RFID tag 10₁₀. However, this is not limited thereto. When there are “1”, “2”, “3”, and “4” other RFID tags 10₁ to 10₁₀ adjacent to the RFID tags 10₁ to 10₁₀ values that are nonlinearly added to each weight Wᵢ, “1”, “2”, “2²”, and “2³”, can be assigned to the RFID tags 10₁ to 10₁₀.

As a result, the weight of the area in which the RFID tags 10₁ to 10₁₀ are concentrated can be increased. The RFID tags 10₁ to 10₁₀ that is even closer to the concentrated area can be extracted.

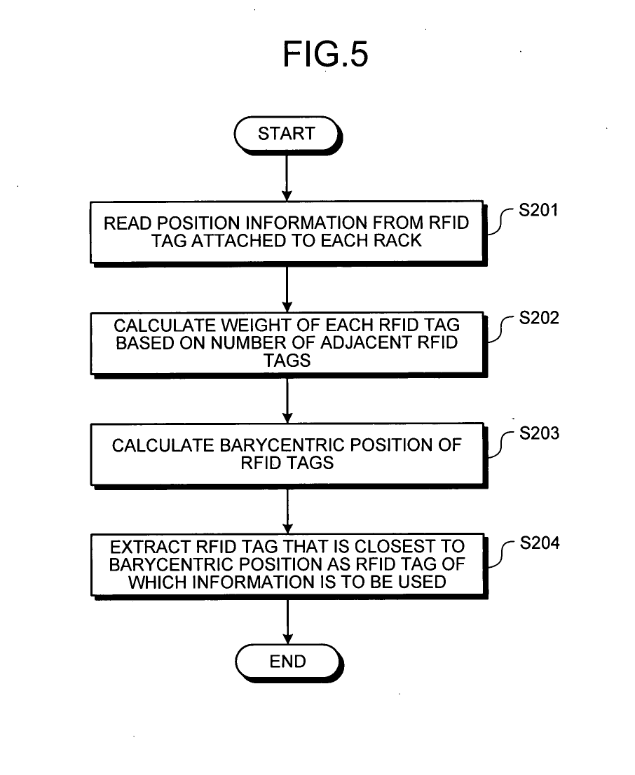

FIG. 5 is a flowchart of procedures performed in the tag extracting process according to the variation example of the first embodiment. The functional configuration of the tag extracting device according to the variation example of the first embodiment is almost the same as that shown in FIG. 2. However, the method used by the barycenter determining unit 45 to calculate the barycentric position differs from that according to the first embodiment.

Therefore, here, the procedures performed in the tag extracting process will be described based on the functional configuration shown in FIG. 2. A functional component equivalent to the barycenter determining unit 45 according to the first embodiment is indicated as the barycenter determining unit 45′.

As shown in FIG. 5, first, the reader/writer controlling unit 43 of the tag extracting device 40 controls the reader/writer 30 and reads the tag position information 21₁ to 21ₙ from the RFID tags 20₁ to 20ₙ attached to each rack used to load and unload the packages (Step S201).

Then, the barycenter determining unit 45′ calculates the weight Wᵢ of each RFID tag 20₁ to 20ₙ, based on the number of adjacent RFID tags 20₁ to 20ₙ, using a method such as that described in FIG. 4 (Step S202).

Next, the barycenter determining unit 45′ calculates the barycentric position of the RFID tags 20₁ to 20ₙ by using Equations (1) and (2) (Step S203). The tag extracting unit 46 extracts the RFID tags 20₁ to 20ₙ in the position closest to the barycentric position as the RFID tag of which the information is to be used (Step S204). Then, the tag extracting process is completed.

As described above, according to the variation example of the first embodiment, the barycenter determining unit 45′ determines the weight of the position information related to the RFID tags 20₁ to 20ₙ from which the tag position information 21₁ to 21ₙ has been read, based on the number of RFID tags 20₁ to 20ₙ adjacent to the RFID tags 20₁ to 20ₙ. Therefore, the weight of the position information related to the RFID tags 20₁ to 20ₙ can be appropriately assigned. The position in which the RFID tags 20₁ to 20ₙ from which the tag position information 21₁ to 21ₙ has been read are concentrated can be more accurately determined.

According to the first embodiment and the variation example of the first embodiment, when the position coordinates of the RFID tags 10₁ to 10₁₀ are indicated by a two-dimensional coordinate system including two axes, the X axis and the Y axis, is described. However, in actuality, each rack used to load and unload the packages is disposed three-dimensionally. Therefore, the position coordinates of the RFID tag attached to each rack is indicated by a three-dimensional coordinate system including three axes, the X axis, the Y axis, and a Z axis. As a result, the barycentric position of the RFID tag is required to be calculated three-dimensionally.

In this case as well, by the method explained in FIG. 1 or FIG. 4 being extended to include the three dimensional coordinate system including the z axis and used, the barycentric position of the RFID tags in the three dimensional coordinate system is calculated, and the process of reading the necessary information from the RFID tag can be efficiently performed.

According to the first embodiment and the variation example of the first embodiment, the barycentric position of each RFID tag 10₁ to 10₁₀ to which the weight is assigned is calculated. The RFID tags 10₁ to 10₁₀ closest to the calculated barycentric position is extracted as the RFID tags 10₁ to 10₁₀ of which the information is to be used. However, this is not limited thereto. Merely the RFID tag 10₁ to RFID tag 10₁₀ assigned with a largest weight Wᵢ can be extracted as the RFID tags 10₁ to 10₁₀ of which the information is used.

Furthermore, according to the first embodiment and the variation example of the first embodiment, the barycentric position of the RFID tags 10₁ to 10₁₀ is calculated based on the position information stored in the RFID tags 10₁ to 10₁₀. However, when identification (ID) information identifying each RFID tag 10₁ to 10₁₀ is stored in the RFID tags 10₁ to 10₁₀ and the ID information is read from the RFID tags 10₁ to 10₁₀, the position information of the RFID tags 10₁ to 10₁₀ₙ can be read from a database in which the ID information and the position information of the RFID tags 10₁ to 10₁₀ are associated and stored in a memory or the like. Then, the barycentric position can be calculated.

According to the first embodiment, when the unnecessary information read from the RFID tag as a result of the reflection or the wraparound phenomenon of the communication radio waves is excluded is described. However, when the necessary information is read from the RFID tag, the RFID tag from which the information cannot be read as a result of a failure can be extracted as well. Therefore, when a defective RFID tag is extracted will be described according to a second embodiment.

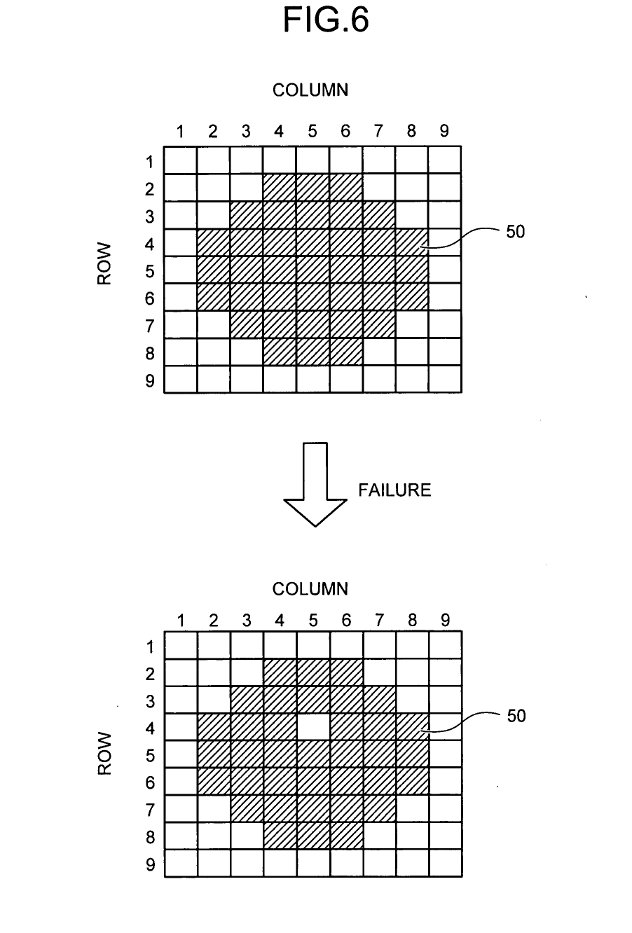

First, a tag extracting process according to the second embodiment will be described. FIG. 6 is an explanatory diagram of the tag extracting process according to the second embodiment. In the example in FIG. 6, when each RFID tag 50 is positioned in a 9-by-9 position coordinate system is shown.

In the tag extracting process, the reader/writer communicates a plural number of times with a plurality of RFID tags 50 using radio waves and detects an RFID tag 50 with which communication is possible.

Then, the reader/writer performs a process of extracting the RFID tag 50 positioned between detected RFID tags 50 and from which information can not be read as the defective RFID tag. FIG. 6 shows when an RFID tag 50 positioned in a fourth row in a fifth column is extracted as the defective RFID tag.

In the tag extracting process, the RFID tag 50 from which the information cannot be read is not merely extracted as the defective RFID tag, but whether the RFID tag 50 is in a position sandwiched between the detected RFID tags 50 is judged.

If the RFID tag 50 from which the information cannot be read is positioned between the RFID tags 50 detected by the reader/writer, the information can be read from the RFID tag 50 positioned nearby. Therefore, it is unlikely that the information is unreadable due to radio wave interference of some sort. It is more likely that the RFID tag 50 from which the information cannot be read is defective.

In this way, in the tag extracting process, the detection of the defective RFID tag 50 is effectively performed during a process of detecting the rack used to load and unload the packages. Exchange is facilitated and reliability of defect detection can be enhanced.

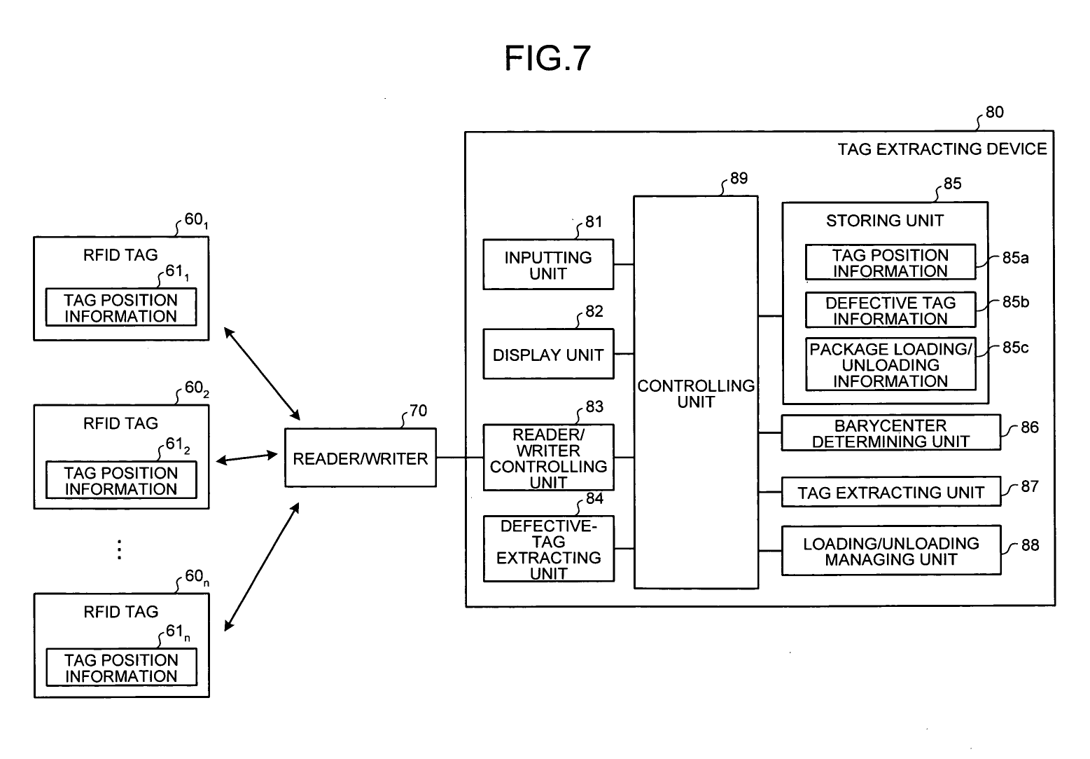

Next, a functional configuration of the tag extracting device according to the second embodiment will be described. FIG. 7 is a diagram of the functional configuration of the tag extracting device 80 according to the second embodiment. As shown in FIG. 7, the tag extracting device 80 is connected to a reader/writer 70.

The reader/writer 70 and RFID tags 60₁ to 60ₙ are the same as the reader/writer 30 and the RFID tags 20₁ to 20ₙ shown in FIG. 2. Tag position information 61₁ to 61ₙ stored in the RFID tags 60₁ to 60ₙ are the same as the tag position information 21₁ to 21ₙ in FIG. 2.

The tag extracting device 80 is provided in a forklift or the like on which the reader/writer 70 is mounted. When the RFID tags 60₁ to 60ₙ are attached to the rack used to load and unload the packages, the tag extracting device 80 reads the tag position information 61₁ to 61ₙ stored in the RFID tags 60₁ to 60ₙ and performs a process of confirming whether the rack is used to load and unload the packages or the like.

As described according to the first embodiment, when the tag extracting device 80 reads information from the RFID tags 60₁ to 60ₙ that is not the readable object and is positioned away from the reader/writer 70 as a result of the reflection or the wraparound phenomenon of the radio waves, the tag extracting device 80 also excludes the information read from the RFID tags 60₁ to 60ₙ that is not the readable object.

Furthermore, the tag extracting device 80 performs a process of extracting defective RFID tags 60₁ to 60ₙ, in adherence to the method described with reference to FIG. 6.

The tag extracting device 80 includes an inputting unit 81, a display unit 82, a reader/writer controlling unit 83, a defective-tag extracting unit 84, a storing unit 85, a barycenter determining unit 86, a tag extracting unit 87, a loading/unloading managing unit 88, and a controlling unit 89.

The inputting unit 81, the display unit 82, the reader/writer controlling unit 83, the barycenter determining unit 86, the tag extracting unit 87, the loading/unloading managing unit 88, and the controlling unit 89 are the same as the inputting unit 41, the display unit 42, the reader/writer controlling unit 43, the barycenter determining unit 45, the tag extracting unit 46, the loading/unloading managing unit 47, and the controlling unit 48 described in FIG. 2.

Using the method described with reference to FIG. 6, the defective-tag extracting unit 84 performs a process in which the RFID tags 60₁ to 60ₙ from which the information could not be read, positioned between the RFID tags 60₁ to 60ₙ from which the information has been read, is extracted as the defective RFID tag.

The storing unit 85 is the storage device such as the hard disk device. The storing unit 85 stores tag position information 85a, defective tag information 85b, and package loading/unloading information 85c.

The tag position information 85a and the package loading/unloading information 85c are the same as the tag position information 44a and the package loading/unloading information 44b described in FIG. 2. The defective tag information 85b is information on a position of a defective RFID tag 60₁ to RFID tag 60ₙ extracted by the defective-tag extracting unit 84.

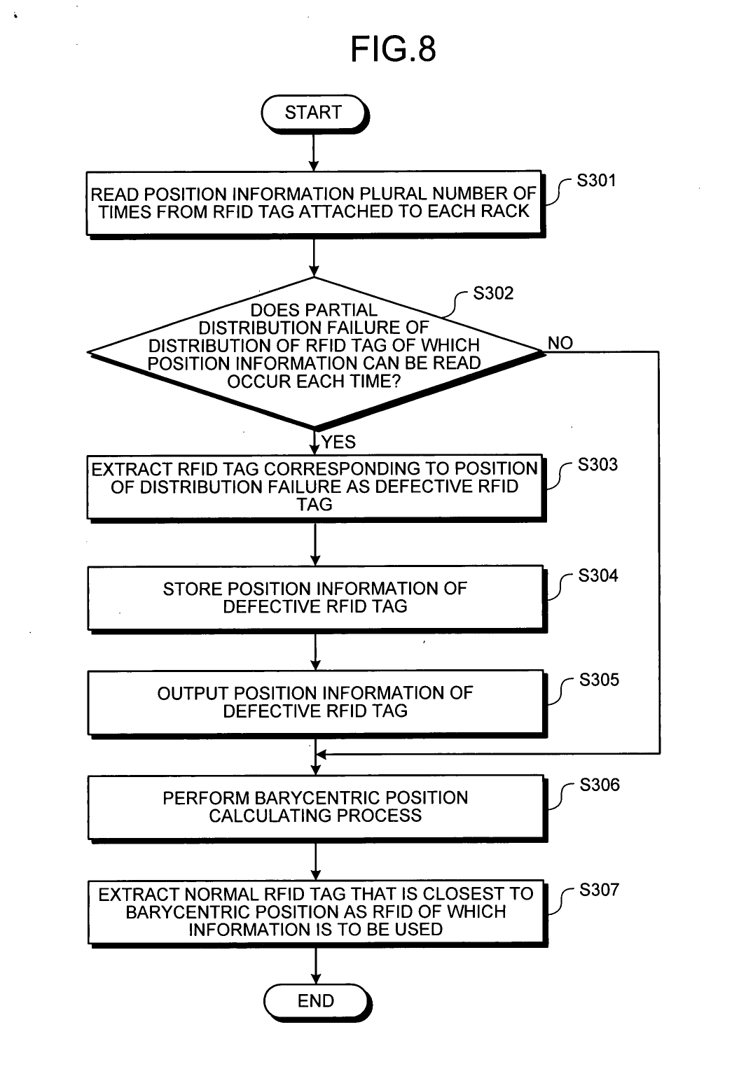

Next, procedures performed in the tag extracting process according to the second embodiment will be described. FIG. 8 is a flowchart of the procedures performed in the tag extracting process according to the second embodiment.

First, the reader/writer controlling unit 83 of the tag extracting device 80 controls the reader/writer 70 and reads the tag position information 61₁ to 61ₙ a plural number of times from the RFID tags 60₁ to 60ₙ attached to each rack used to load and unload the packages (Step S301).

Then, the defective-tag extracting unit 84 examines whether a partial distribution failure of a distribution of the RFID tags 60₁ to 60ₙ from which the tag position information 61₁ to 61ₙ can be read has occurred each time (Step S302).

Specifically, when the RFID tags 60₁ to 60ₙ from which the tag position information 61₁ to 61ₙ cannot be read is sandwiched between the RFID tags 50 from which the tag position information 61₁ to 61ₙ can be read, the defective-tag extracting unit 84 judges that the partial distribution failure of the distribution of the RFID tags 60₁ to 60ₙ has occurred.

If the partial distribution failure of the distribution of the RFID tags 60₁ to 60ₙ does not always occur each time (No at Step S302), the barycenter determining unit 86 performs the process of calculating the barycentric position, in adherence to a method such as those described according to the first embodiment or the variation example of the first embodiment (Step S306).

Then, the tag extracting unit 87 extracts a non-defective, normal RFID tags 60₁ to 60ₙ positioned closest to the barycentric position as the RFID tag of which the information is to be used (Step S307). The tag extracting process is completed.

At Step S302, when the partial distribution failure of the distribution of the RFID tags 60₁ to 60ₙ occurs each time (Yes at Step S302), the defective-tag extracting unit 84 extracts the RFID tags 60₁ to 60ₙ corresponding to the position at which the distribution of the RFID tags 60₁ to 60ₙ is missing as the defective RFID tags 60₁ to 60ₙ (Step S303).

Then, the defective-tag extracting unit 84 stores the position information of the defective RFID tags 60₁ to 60ₙ in the storing unit 85 as the defective tag information 85b (Step S304). Furthermore, the defective-tag extracting unit 84 outputs the position information of the defective RFID tags 60₁ to 60ₙ to the display unit 82 (Step S305).

Next, the process proceeds to Step 306. The barycenter determining unit 86 performs the process of calculating the barycentric position. At Step S307, the tag extracting unit 87 extracts the RFID tags 60₁ to 60ₙ that is positioned closest to the barycentric position as the RFID tag of which the information is to be used. The tag extracting process is completed.

As described above, according to the second embodiment, when the tag position information 61₁ to 61ₙ is stored in each RFID tag 60₁ to 60ₙ, the reader/writer controlling unit 83 controls the reading of the tag position information 61₁ to 61ₙ stored in a plurality of RFID tags 60₁ to RFID tags 60ₙ. Based on the tag position information 61₁ to 61ₙ read by the reader/writer controlling unit 83, the defective-tag extracting unit 84 extracts the RFID tags 60₁ to 60ₙ from which the information cannot be read, positioned between the RFID tags 60₁ to 60ₙ from which the tag position information 61₁ to 61ₙ has been read, as the defective RFID tags 60₁ to 60ₙ. Therefore, by the detection of the defective RFID tags 60₁ to 60ₙ needless repetition of the reading process to read the necessary information can be prevented. The information reading process can be made more efficient.

According to the second embodiment, the defective one of the RFID tags 60₁ to 60ₙ is extracted based on the position information stored in the RFID tags 60₁ to 60ₙ. However, when the ID information identifying each RFID tag 60₁ to 60ₙ is stored in the RFID tags 60₁ to 60ₙ and the ID information is read from the RFID tags 60₁ to 60ₙ the position information of the RFID tags 60₁ to 60ₙ can be read from a database in which the ID information and the position information of the RFID tags 60₁ to 60ₙ are associated and stored in a memory or the like. The read position information can be used to extract the defective RFID tag 60₁ to RFID tag 60ₙ.

According to the first embodiment and the variation example of the first embodiment, when the unnecessary information read from the RFID tag as a result of the reflection of the communication radio waves is excluded by the calculation of the barycentric position of the RFID tag is described. However, communication can be performed with the RFID tag using the radio waves, while changing the position of the antenna. The RFID tag from which the unnecessary information has been read as a result of the reflection of the communication radio waves can be detected and the information read from the detected RFID tag can be excluded.

Specifically, when a metal surface is present near the location at which radio wave communication is performed, the communication radio waves transmitted from the antenna attached to the reader/writer may be reflected by the metal surface and reach an RFID tag differing from the RFID tag of which the information should be read. Response waves transmitted from the RFID tag may be reflected by the metal surface and received by the reader/writer.

In this case, a reflection direction of the communication radio waves changes significantly even with a slight change in a position of the antenna. Therefore, the RFID tag from which the information has been read as a result of the reflection of the radio waves due to the metal surface is not detected.

According to a third embodiment, using the above-described characteristics, when an unnecessary RFID tag from which the information has been read as a result of the reflection of the communication radio wave is excluded and the RFID tag from which the information has been read using the direct radio waves is extracted, as a result of the communication with the RFID tag using the radio waves while changing the position of the antenna will be explained.

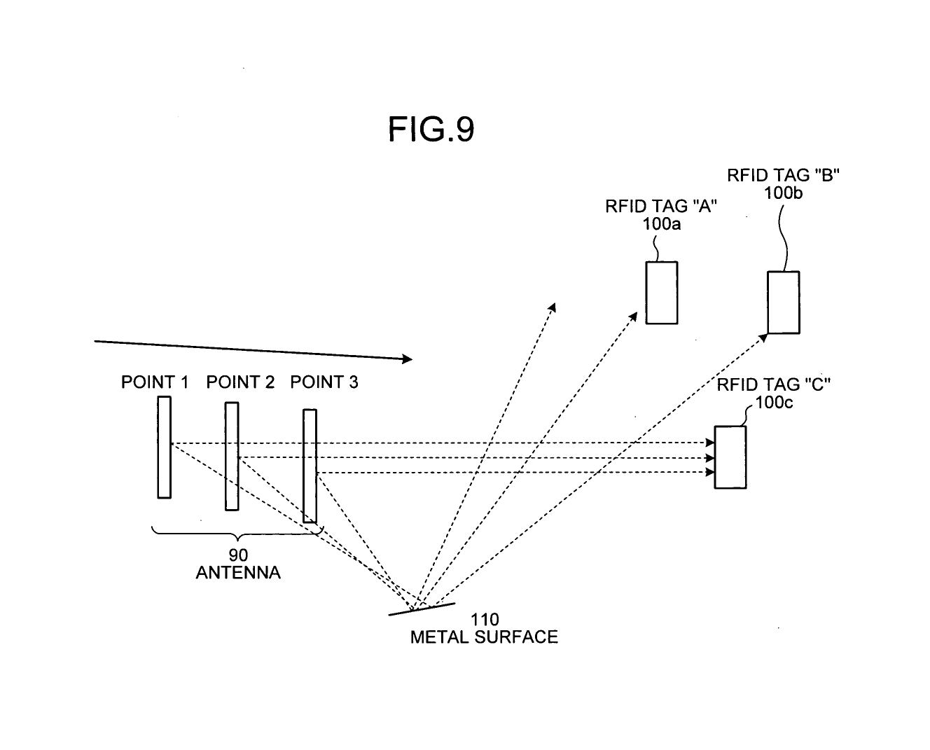

First, a tag extracting process according to the third embodiment will be described. FIG. 9 is an explanatory diagram of the tag extracting process according to the third embodiment.

In the example in FIG. 9, when three RFID tags, RFID tag “A” 100a, RFID tag “B” 100b, and RFID tag “C” 100c are present is shown. Here, the RFID tag “A” 100a and the RFID tag “B” 100b are not information readable objects. The RFID tag “C” 100c is an information readable object.

When an antenna 90 is at a point 1, a directivity of the antenna 90 is adjusted to allow radio wave communication between the reader/writer and the RFID tag “C” 100c. However, the communication radio waves transmitted from the antenna 90 also reaches the RFID tag “B” 100b, in addition to the RFID tag “C” 100c, as a result of reflection by the metal surface 110. Response waves from the RFID tag “B” 100b are also received.

When the antenna 90 is at a point 2, the communication radio waves transmitted from the antenna 90 also reaches the RFID tag “A” 100a, in addition to the RFID tag “C” 100c, as a result of the reflection by the metal surface 110. Response waves from the RFID tag “A” 100a are also received.

However, at the point 2, communication between the antenna 90 and the RFID tag “B” 100b cannot be performed because the position of the antenna 90 has changed. Communication between the antenna 90 and the RFID tag “C” 100c remains possible.

Furthermore, when the antenna 90 is at a point 3, the communication between the antenna 90 and the RFID tag “A” 100a and the antenna 90 and the RFID tag “B” 100b cannot be performed. Communication can only be performed between the antenna 90 and the RFID tag “C” 100c.

In the tag extracting process, communication is performed between the antenna and each RFID tag while changing the position of the antenna in this way. The RFID tag with which communication cannot be performed as a result of the change in the position of the antenna is excluded as the RFID tag from which the information has been read as a result of the reflection of the radio waves. A process is performed in which an RFID tag with a high reading success rate is extracted as the RFID tag of which the information is to be used.

As a result, the process of reading the necessary information from the RFID tag can be efficiently performed. In an actual communication environment, even when the information is read using the direct radio waves, a success rate of information reading is not necessarily 100%. A success rate threshold when the information is extracted is about 80% to 90% and is adjusted according to a local environment.

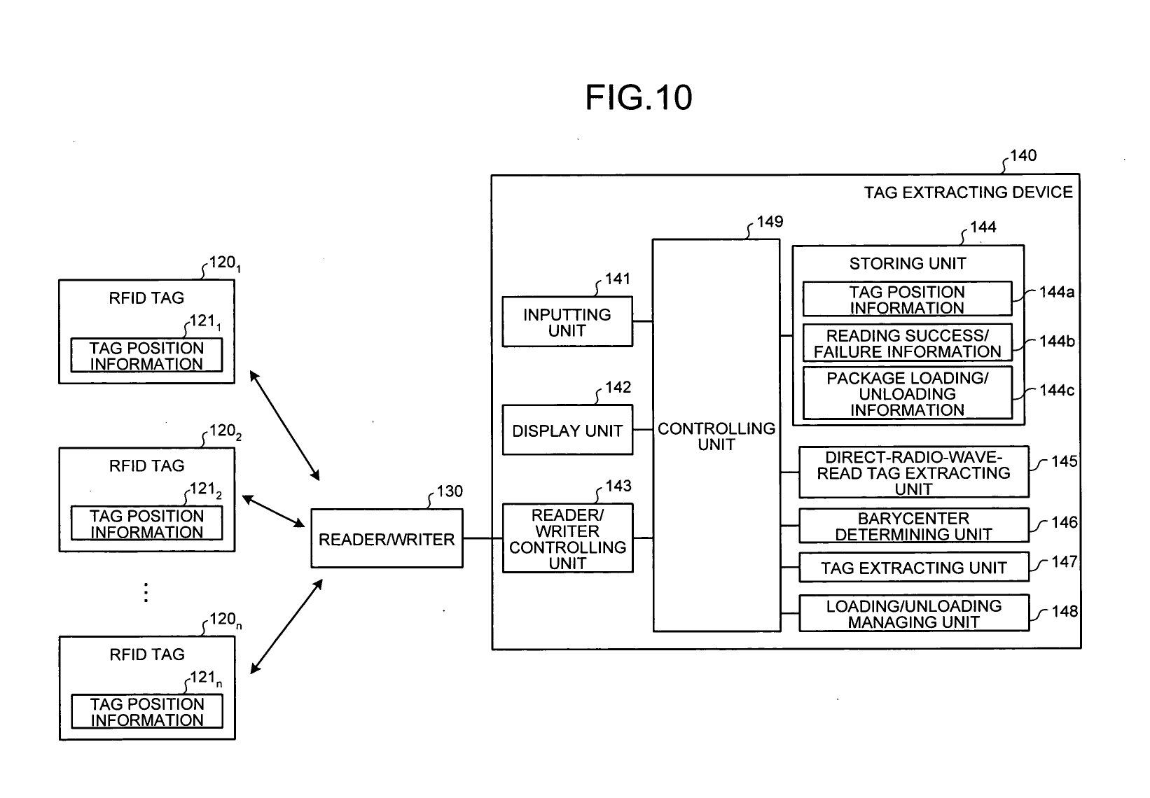

Next, a functional configuration of the tag extracting device according to the third embodiment will be described. FIG. 10 is a diagram of a functional configuration of the tag extracting device 140 according to the third embodiment. The tag extracting device 140 is connected to a reader/writer 130.

The reader/writer 130 and RFID tags 120₁ to 120ₙ are the same as the reader/writer 30 and the RFID tags 20₁ to 20ₙ in FIG. 2. Tag position information 121₁ to 121ₙ stored in the RFID tags 120₁ to 120ₙ are the same as the tag position information 21₁ to 21ₙ in FIG. 2.

The tag extracting device 140 is provided in a forklift or the like on which the reader/writer 130 is mounted. When the RFID tags 120₁ to 120ₙ are attached to the racks used to load and unload the packages, the tag extracting device 140 reads the tag position information 121₁ to 121ₙ stored in the RFID tags 120₁ to 120ₙ and performs a process of confirming whether the rack is used to load and unload the packages.

The tag extracting device 140 does not merely perform a confirmation process of the rack. When the reader/writer 130 reads the information from the RFID tags 120₁ to 120ₙ that is not the readable object as a result of the reflection of the radio waves, the tag extracting device 140 detects the RFID tags 120₁ to 120ₙ that is not the readable object and excludes the information read from the RFID tags 120₁ to 120ₙ that is not the readable object.

The tag extracting device 140 includes an inputting unit 141, a display unit 142, a reader/writer controlling unit 143, a storing unit 144, a direct-radio-wave-read tag extracting unit 145, a barycenter determining unit 146, a tag extracting unit 147, a loading/unloading managing unit 148, and a controlling unit 149.

Here, the inputting unit 141, the display unit 142, the loading/unloading managing unit 148, and the controlling unit 149 are the same as the inputting unit 41, the display unit 42, the loading/unloading managing unit 47, and the controlling unit 48 in FIG. 2.

The reader/writer controlling unit 143 controls the radio wave communication performed between the reader/writer 130 and the RFID tags 120₁ to 120ₙ. Specifically, the reader/writer controlling unit 143 requests that the reader/writer 130 transmits the communication radio waves to the RFID tags 120₁ to 120ₙ. The reader/writer controlling unit 143 also controls the intensity of the communication radio waves.

When the forklift on which the reader/writer 130 and the tag extracting device 140 are mounted moves, the reader/writer controlling unit 143 performs a process of reading the tag position information 121₁ to 121ₙ from each RFID tag 120₁ to 120ₙ at a plurality of different points.

Then, the reader/writer controlling unit 143 stores information regarding whether the tag position information 121₁ to 121ₙ can be read from each RFID tag 120₁ to RFID tag 120ₙ as reading success/failure information 144b.

The storing unit 144 is the storage device such as the hard disk device. The storing unit 144 stores tag position information 144a, the reading success/failure information 144b, and package loading/unloading information 144c.

The tag position information 144a and the package loading/unloading information 144c are the same as the tag position information 44a and the package loading/unloading information 44b in FIG. 2. The reading success/failure information 144b stores information on whether the reading of the tag position information 121, to 121, has been successful when the tag position information 121₁ to 121ₙ is read from the RFID tags 120₁ to 120ₙ while changing the position of the antenna.

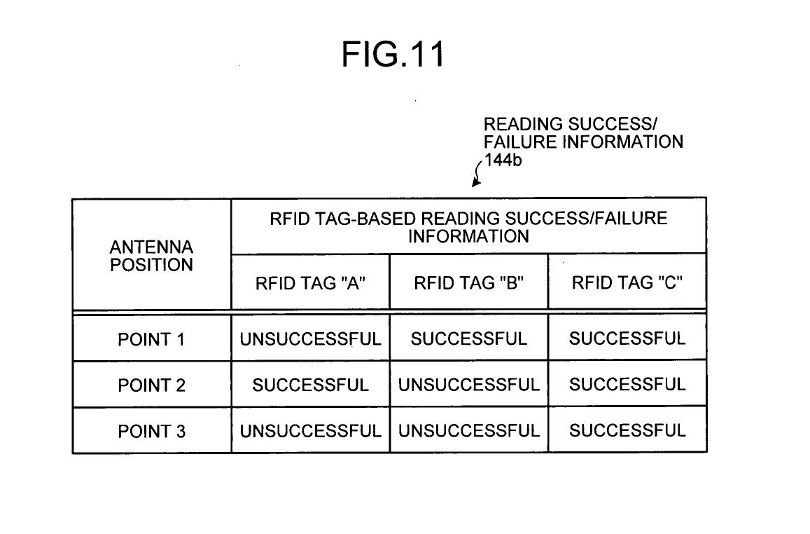

FIG. 11 is a diagram of an example of the reading success/failure information 144b in FIG. 10. The reading success/failure information 144b stores the antenna position and RFID tag-based reading success/failure information.

The antenna position is information regarding the position of the antenna 90 when the process of reading the tag position information 121₁ to 121ₙ from the RFID tags 120₁ to 120ₙ is performed. The RFID tag-based reading success/failure information stores information on whether the reading of the tag position information 121₁ to 121ₙ from each RFID tag 120₁ to 120ₙ has been successful at each antenna 90 position.

For example, in the example in FIG. 11, as shown in FIG. 9, when the antenna 90 is at the point 1, success/failure of the reading of the information of the RFID tag “A” 100a, the RFID tag “B” 100b, and the RFID tag “C” 100c are respectively “unsuccessful”, “successful”, and “successful”.

When the antenna 90 is at the point 2, success/failure of the reading of the information of the RFID tag “A” 100a, the RFID tag “B” 100b, and the RFID tag “C” 100c are respectively “successful”, “unsuccessful”, and “successful”.

When the antenna 90 is at the point 3, success/failure of the reading of the information of the RFID tag “A” 100a, the RFID tag “B” 100b, and the RFID tag “C” 100c are respectively “unsuccessful”, “unsuccessful”, and “successful”.

Returning to the explanation with reference to FIG. 10, the direct-radio-wave-read tag extracting unit 145 excludes the RFID tag read as a result of the reflection of the radio waves, using the method described in FIG. 9, based on the reading success/failure information 144b stored in the storing unit 144. The direct-radio-wave-read tag extracting unit 145 performs a process of extracting the RFID tags 120₁ to 120ₙ having a high information reading success rate as the RFID tag from which information is read using direct radio waves.

Specifically, the direct-radio-wave-read tag extracting unit 145 calculates the reading success rate of each RFID tag 120₁ to RFID tag 120ₙ at each antenna position. For example, in the example in FIG. 11, the reading success rate of the RFID tag “A” 100a is 33.3%, the reading success rate of the RFID tag “B” 100b is 33.3%, and the reading success rate of the RFID tag “C” 100c is 100%.

Then, the direct-radio-wave-read tag extracting unit 145 compares the success rate with a predetermined threshold and performs a process of extracting the RFID tag “C” 100c having a higher success rate than the threshold.

As described with reference to FIG. 1, the barycenter determining unit 146 performs a process of determining the barycentric position of each RFID tag 120₁ to RFID tag 120ₙ extracted by the direct-radio-wave-read tag extracting unit 145, by using Equations (1) to (3).

The tag extracting unit 147 extracts the RFID tags 120₁ to 120ₙ closest to the barycentric position determined by the barycenter determining unit 146 as the RFID tag of which the information is to be used and excludes the RFID tags 120₁ to 120ₙ read as a result of the wraparound phenomenon of the radio waves.

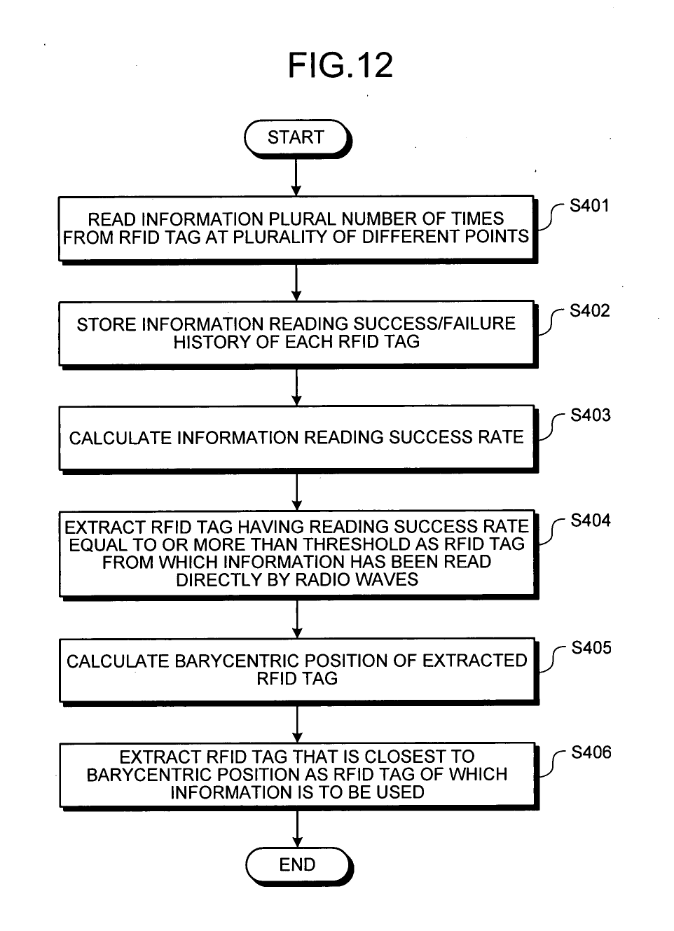

Next, procedures performed in the tag extracting process according to the third embodiment will be described. FIG. 12 is a flowchart of the procedures performed in the tag extracting process according to the third embodiment. The tag extracting process is performed while the forklift on which the reader/writer 130 and the tag extracting device 140 are mounted is moving, as shown in FIG. 9.

As shown in FIG. 12, first, the reader/writer controlling unit 143 of the tag extracting device 140 performs control to read the tag position information 121₁ to 121ₙ a plural number of times from each RFID tag 120₁ to RFID tag 120ₙ at the different points (Step S401).

Then, the reader/writer controlling unit 143 stores a history of whether the reading of the tag position information 121₁ to 121ₙ from each RFID tags has been successful as the reading success/failure information 144b in the storing unit 144 (Step S402).

Next, the direct-radio-wave-read tag extracting unit 145 calculates the reading success rate of the tag position information 121₁ to 121ₙ (Step S403). The direct-radio-wave-read tag extracting unit 145 extracts the RFID tags 120₁ to 120ₙ having a success rate equal to or more than a predetermined threshold as the RFID tag from which the information is read using the direct radio waves (Step S404).

Next, the barycenter determining unit 146 calculates the barycentric position of the RFID tags 120₁ to 120ₙ extracted by the direct-radio-wave-read tag extracting unit 145 using a method such as those described in FIG. 1 or FIG. 4 (Step S405).

Then, the tag extracting unit 147 extracts the RFID tags 120₁ to 120ₙ closest to the barycentric position as the RFID of which the information is to be used (Step S406). The tag extracting process is completed.

As described above, according to the third embodiment, the reader/writer controlling unit 143 controls the reading of the tag position information 121₁ to 121ₙ stored in a plurality of RFID tags 120₁ to RFID tags 120ₙ respectively performed at different positions of the antenna 90. The storing unit 144 stores information on whether the tag position information 121₁ to 121ₙ stored in each RFID tag 120₁ to RFID tag 120ₙ can be read at each position of the antenna 90. The direct-radio-wave-read tag extracting unit 145 and the tag extracting unit 147 extracts the RFID tags 120₁ to 120ₙ storing the tag position information 121₁ to 121ₙ to be used, based on the information stored in the storing unit 144. Therefore, the unnecessary information of the RFID tags 120₁ to 120ₙ read as a result of the reflection of the communication radio waves is excluded, and the process of reading the necessary information from the RFID tags 120₁ to 120ₙ can be efficiently performed.

According to the third embodiment, the direct-radio-wave-read tag extracting unit 145 judges whether the success rate of the reading of the information from the RFID tags 120₁ to 120ₙ respectively performed at the different antenna 90 positions is equal to or more than the predetermined threshold. Based on the judgment result, the tag extracting unit 147 extracts the RFID tags 120₁ to 120ₙ as the RFID tag storing the information to be used. Therefore, reliability of the extracting process of the RFID tags 120₁ to 120ₙ can be adjusted in adherence to an actual environment in which the radio wave communication is performed. The process of reading the necessary information from the RFID tag 120₁ to 120ₙ can be efficiently performed.

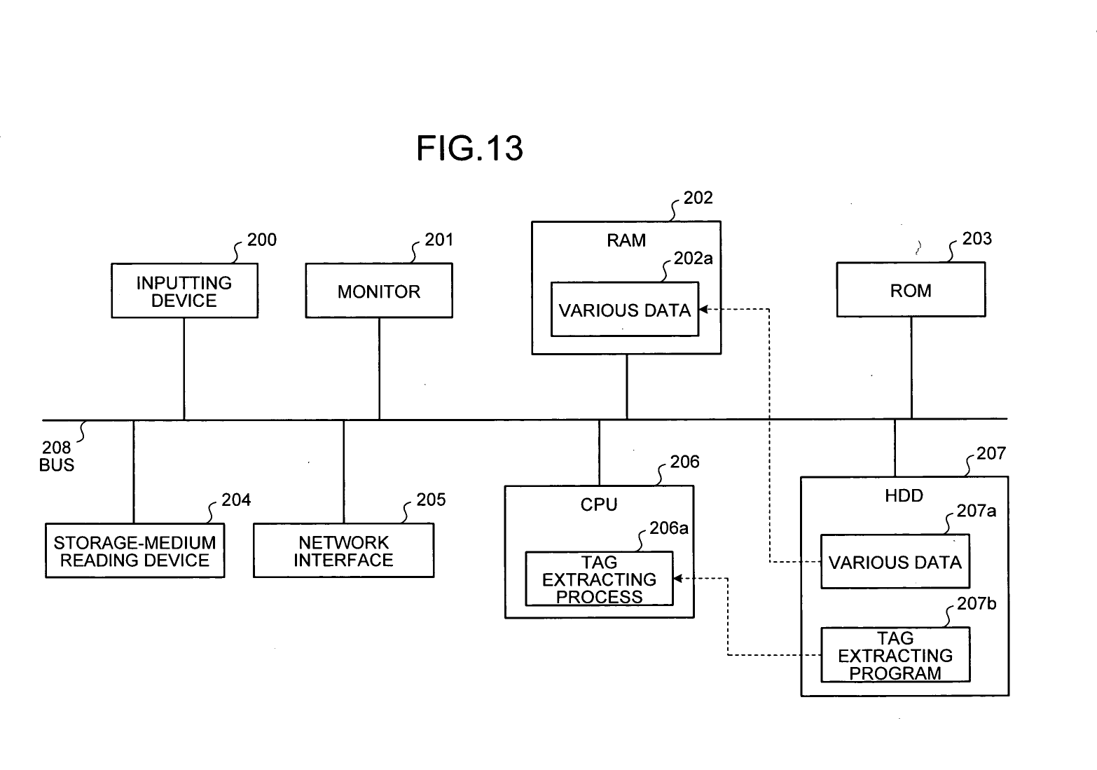

The various processes described in the above embodiments can be actualized by a computer running a program provided in advance. Hereafter, an example of the computer running the program actualizing the various processes will be described with reference to FIG. 13.

FIG. 13 is a diagram of a hardware configuration of a computer serving as the tag extracting device 40 shown in FIG. 1, the tag extracting device 80 shown in FIG. 7, and the tag extracting device 140 shown in FIG. 10.

The computer includes an inputting device 200, a monitor 201, a random-access memory (RAM) 202, a read-only memory (ROM) 203, a storage medium reading device 204, a network interface 205, a central processing unit (CPU) 206, and a hard disk drive (HDD) 207 that are connected by a bus 208. The inputting device 200 receives an input of data from a user. The storage medium reading device 204 reads a program from a storage medium storing various programs. The network interface 205 is used to exchange of data with another computer, via a network.

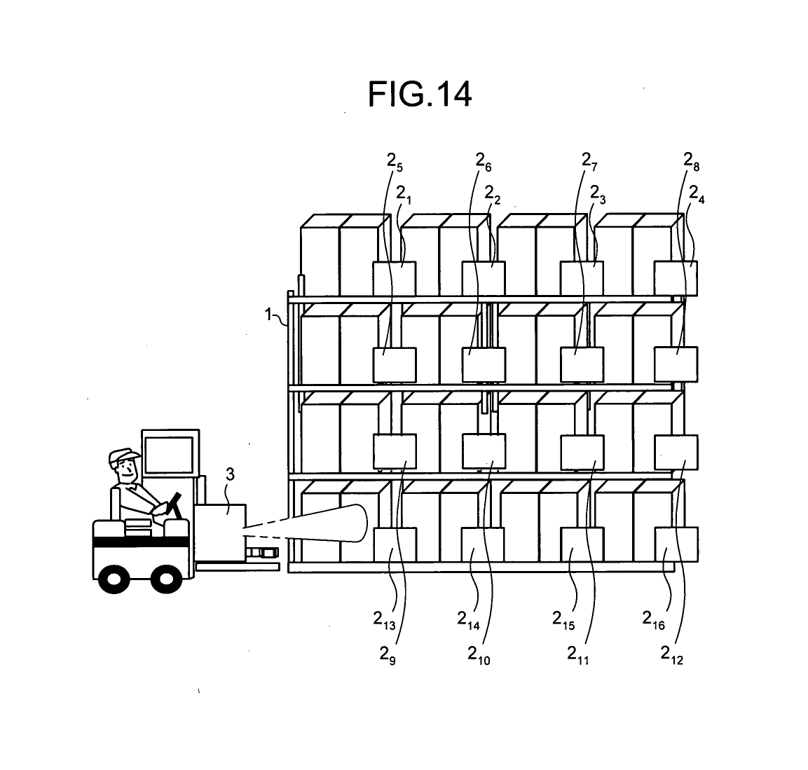

The HDD 207 stores therein a computer program for achieving same functions as functions of the tag extracting device 40, the tag extracting device 80, and the tag extracting device 140. In other words, a tag extracting program 207b shown in FIG. 14 is stored. The tag extracting program 207b can be appropriately distributed and stored.

The CPU 206 reads the tag extracting program 207b from the HDD 207 and executes the tag extracting program 207b, thereby functioning as a tag extracting process 206a. The tag extracting process 206a actualizes respective functions of the tag extracting device 40 in FIG. 2, the tag extracting device 80 in FIG. 7, and the tag extracting device 140 in FIG. 10.

The HDD 207 also stores various data 207a. The various data 207a correspond to the tag position information 44a and the package loading/unloading information 44b in FIG. 2, the tag position information 85a, the defective tag information 85b, and the package loading/unloading information 85c in FIG. 7, and the tag position information 144a, the reading success/failure information 144b, and the package loading/unloading information 144c in FIG. 10.

The CPU 206 stores the various data 207a in the HDD 207. Furthermore, the CPU 206 reads the various data 207a from the HDD 207 and stores the various data 207a in the RAM 202. The CPU 206 performs data processing based on various data 202a stored in the RAM 202.

The tag extracting program 207b is not necessarily required to be stored in the HDD 207 from the start. For example, each program can be stored in a “portable physical medium”, a “fixed physical medium”, or “another computer (or server)”. The “portable physical medium” includes a flexible disk (FD), a compact disc read-only memory (CD-ROM), a magneto-optical (MO) disk, a digital versatile disk (DVD), a magneto-optical disk, an IC card, and the like that are inserted into the computer. The “fixed physical medium” includes a HDD and the like provided inside or outside of the computer. The “other computer (or server)” is connected to the computer via a public circuit, the internet, a local area network (LAN), a wide area network (WAN), and the like. The computer can read each program and run the read program.

The embodiments of the present invention have been described herein. However, in addition to the embodiments described above, various different embodiments can be implemented within the scope of the claims.

For example, according to the embodiments, the reader/writer is attached to a forklift. However, the reader/writer can be a portable-type that can be carried.

Among the processes described above, all or some processes described to be performed automatically can be performed manually. On the other hand, all or some processes described to be performed manually can be performed automatically, as a result of a known method.

Processing procedures, controlling procedures, specific names, information including various data and parameters within the specifications and the drawings can be arbitrarily modified unless noted otherwise.

Each constituent element of each device shown in the drawings is functionally conceptual. Constituent elements are not necessarily required to be physically configured as shown in the drawings. In other words, a specific form of distribution and unification of each device is not limited to that shown in the drawings. All or some devices can be configured by being functionally or physically distributed or unified in an arbitrary unit, depending on various loads and usage conditions.

Furthermore, all or an arbitrary number of various processing functions performed by each device can be actualized by the CPU or a program analytically run by the CPU or can be actualized as hardware by wired logic.

According to an aspect of the present invention, the unnecessary information of the RFID tag read as a result of the reflection or the wraparound phenomenon of the communication radio waves is excluded. Therefore, the process of reading the necessary information from the RFID tag can be efficiently performed.

According to another aspect of the present invention, the unnecessary information of the RFID tag read as a result of the reflection or the wraparound phenomenon of the communication radio waves is excluded by the barycentric position being determined. The process of reading the necessary information from the RFID tag can be efficiently performed.

According to still another aspect of the present invention, the position in which the RFID tags of which the position information can be read are concentrated can be more accurately determined.

According to still another aspect of the present invention, the weight of the position information related to the RFID tag can be appropriately assigned. Therefore, position in which the RFID tags of which the position information can be read are concentrated can be more accurately determined.

According to still another aspect of the present invention, the weight of the position information related to the RFID tag can be appropriately assigned. Therefore, the position in which the RFID tags of which the position information can be read are concentrated can be more accurately determined.

According to still another aspect of the present invention, by the defective RFID tag being detected, the reading process being needlessly repeated to read the necessary data can be prevented. Therefore, the process of reading information can be efficiently performed.

According to still another aspect of the present invention, the unnecessary information of the RFID tag read as a result of the reflection or the wraparound phenomenon of the communication radio waves is excluded. Therefore, the process of reading the necessary information from the RFID tag can be efficiently performed.

According to still another aspect of the present invention, the reliability of the RFID tag extracting process can be adjusted in adherence to the actual environment in which the radio wave communication is performed. Therefore, the process of reading the necessary information from the RFID tag can be efficiently performed.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A tag extracting device that extracts an RFID tag from among a plurality of RFID tags that store therein position information and other information, the tag extracting device comprising:
a reading unit that reads position information from a plurality of information-read RFID tags from among the plurality of RFID tags;
a determining unit that determines, based on read position information, a concentration area that is an area in which the information-read RFID tags are concentrated; and
an extracting unit that extracts at least one RFID tag from among the information-read RFID tags as a target RFID tag whose the other information is to be used in subsequent processing.

2. The tag extracting device according to claim 1, wherein the determining unit calculates a barycentric position from the position information read from the information-read RFID tags, and determines the concentration area based on the barycentric position.

3. The tag extracting device according to claim 2, wherein the determining unit calculates a weight value for each of the information-read RFID tags based on distances between other of the information-read RFID tags, and calculates the barycentric position based on the weight value and the position information of the information-read RFID tags.

4. The tag extracting device according to claim 3, wherein
the determining unit allocates a default weight value to a weight-value calculation target RFID tag from among the information-read RFID tags,
if n number of information-read RFID tags are adjacent to the weight-value calculation target RFID tag in a first direction, the determining unit calculates a first weight value by adding n-times a predetermined value to the default weight value,
if n number of information-read RFID tags are adjacent to the weight-value calculation target RFID tag in a second direction, which is perpendicular to the first direction, the determining unit calculates a second weight value by adding n-times the predetermined value to the default weight value,
if n number of information-read RFID tags are adjacent to the weight-value calculation target RFID tag in a third direction, which is opposite of the first direction and perpendicular to the second direction, the determining unit calculates a third weight value by adding n-times the predetermined value to the default weight value,
if n number of information-read RFID tags are adjacent to the weight-value calculation target RFID tag in a fourth direction, which is opposite of the second direction and perpendicular to the first direction, the determining unit calculates a fourth weight value by adding n-times the predetermined value to the default weight value, and
the determining unit calculates a weight value of the weight-value calculation target RFID tag as the minimum of the first to fourth weight values.

5. The tag extracting device according to claim 3, wherein the determining unit determines a weight value of a weight-value calculation target RFID tag from among the information-read RFID tags based on number of the information-read RFID tags adjacent to the weight-value calculation target RFID tag.

6. A tag extracting device that extracts an RFID tag from among a plurality of RFID tags that store therein position information and other information, the tag extracting device comprising:
a storing unit that stores therein default position information of each of the RFID tags;
a reading unit that reads position information from a plurality of information-read RFID tags from among the plurality of RFID tags; and
an extracting unit that extracts an RFID tag from among the RFID tags other than the information-read RFID tags as a defective RFID tag based on the default position information in the storing unit and the position information read from the information-read RFID tags.

7. A tag extracting device that extracts an RFID tag from among a plurality of RFID tags that store therein position information and other information, the tag extracting device comprising:
a plurality of antennas arranged at different positions and communicable with the RFID tags;
a reading unit configured to read position information from the plurality of RFID tags via the antennas;
a storing unit that stores therein information on each RFID tag about whether the reading unit has successfully read by position information from that RFID tag; and
an extracting unit that extracts at least one RFID tag from among the RFID tags as a target RFID tag whose the other information is to be used in subsequent processing based on the information in the storing unit.

8. The tag extracting device according to claim 7, further comprising a calculating unit that calculates a success rate of reading success of the reading unit, wherein
the extracting unit extracts the target RFID tag based on the success rate.

9. A method of extracting an RFID tag from among a plurality of RFID tags that store therein position information and other information, the method comprising:
reading position information from a plurality of information-read RFID tags from among the plurality of RFID tags;
determining, based on read position information, a concentration area that is an area in which the information-read RFID tags are concentrated; and
extracting at least one RFID tag from among the information-read RFID tags as a target RFID tag whose the other information is to be used in subsequent processing.

10. The method according to claim 9, wherein the determining includes calculating a barycentric position from the position information read from the information-read RFID tags, and determining the concentration area based on the barycentric position.

11. The method according to claim 10, wherein the determining includes calculating a weight value for each of the information-read RFID tags based on distances between other of the information-read RFID tags, and calculating the barycentric position based on the weight value and the position information of the information-read RFID tags.

12. The method according to claim 11, wherein the determining includes
allocating a default weight value to a weight-value calculation target RFID tag from among the information-read RFID tags,
if n number of information-read RFID tags are adjacent to the weight-value calculation target RFID tag in a first direction, calculating a first weight value by adding n-times a predetermined value to the default weight value,
if n number of information-read RFID tags are adjacent to the weight-value calculation target RFID tag in a second direction, which is perpendicular to the first direction, calculating a second weight value by adding n-times the predetermined value to the default weight value,
if n number of information-read RFID tags are adjacent to the weight-value calculation target RFID tag in a third direction, which is opposite of the first direction and perpendicular to the second direction, calculating a third weight value by adding n-times the predetermined value to the default weight value,
if n number of information-read RFID tags are adjacent to the weight-value calculation target RFID tag in a fourth direction, which is opposite of the second direction and perpendicular to the first direction, calculating a fourth weight value by adding n-times the predetermined value to the default weight value, and
calculating a weight value of the weight-value calculation target RFID tag as the minimum of the first to fourth weight values.

13. The method according to claim 11, wherein the determining includes determining a weight value of a weight-value calculation target RFID tag from among the information-read RFID tags based on number of the information-read RFID tags adjacent to the weight-value calculation target RFID tag.

14. A computer-readable recording medium that stores therein a computer program that causes a computer to implement a method of extracting an RFID tag from among a plurality of RFID tags that store therein position information and other information, the computer program causing the computer to execute:
reading position information from a plurality of information-read RFID tags from among the plurality of RFID tags;
determining, based on read position information, a concentration area that is an area in which the information-read RFID tags are concentrated; and
extracting at least one RFID tag from among the information-read RFID tags as a target RFID tag whose the other information is to be used in subsequent processing.

15. The computer-readable recording medium according to claim 14, wherein the determining includes calculating a barycentric position from the position information read from the information-read RFID tags, and determining the concentration area based on the barycentric position.

16. The computer-readable recording medium according to claim 15, wherein the determining includes calculating a weight value for each of the information-read RFID tags based on distances between other of the information-read RFID tags, and calculating the barycentric position based on the weight value and the position information of the information-read RFID tags.

17. The computer-readable recording medium according to claim 16, wherein the determining includes
allocating a default weight value to a weight-value calculation target RFID tag from among the information-read RFID tags,
if n number of information-read RFID tags are adjacent to the weight-value calculation target RFID tag in a first direction, calculating a first weight value by adding n-times a predetermined value to the default weight value,
if n number of information-read RFID tags are adjacent to the weight-value calculation target RFID tag in a second direction, which is perpendicular to the first direction, calculating a second weight value by adding n-times the predetermined value to the default weight value,
if n number of information-read RFID tags are adjacent to the weight-value calculation target RFID tag in a third direction, which is opposite of the first direction and perpendicular to the second direction, calculating a third weight value by adding n-times the predetermined value to the default weight value,
if n number of information-read RFID tags are adjacent to the weight-value calculation target RFID tag in a fourth direction, which is opposite of the second direction and perpendicular to the first direction, calculating a fourth weight value by adding n-times the predetermined value to the default weight value, and
calculating a weight value of the weight-value calculation target RFID tag as the minimum of the first to fourth weight values.

18. The computer-readable recording medium according to claim 16, wherein the determining includes determining a weight value of a weight-value calculation target RFID tag from among the information-read RFID tags based on number of the information-read RFID tags adjacent to the weight-value calculation target RFID tag.
